(19) United States
(12) Patent Application Publication
(10) Pub. No.: US 2017/0163834 A1
(43) Pub. Date: Jun. 8, 2017

(54) IMAGE FORMING APPARATUS CAPABLE OF FORMING IMAGES BASED ON IMAGE DATA, IMAGE FORMING METHOD

(71) Applicant: KYOCERA Document Solutions Inc., Osaka (JP)

(72) Inventor: Rie Miyata, Osaka (JP)

(21) Appl. No.: 15/364,758

(22) Filed: Nov. 30, 2016

(30) Foreign Application Priority Data
Dec. 2, 2015 (JP) 2015-236056

(51) Int. Cl. G03G 15/00; H04N 1/00; H04N 1/29

(52) U.S. Cl. CPC H04N 1/00917; H04N 1/29; G03G 15/50; H04N 2201/0094

(57) ABSTRACT

An image forming apparatus includes a control portion. The control portion executes a print step, a determination step, a setting step, and a resuming step. In the print step, a print process is executed in which images of pages are printed in sequence based on image data including the pages. In the determination step, in a case where the print process has been suspended, it is determined whether a cause of the suspension of the print process is a particular cause. In the setting step, in a case where it has determined that the cause of the suspension of the print process is the particular cause, the resumption page is set in accordance with a user operation. In the resuming step, the print process is resumed from the resumption page set in the setting step.

### INCORPORATION BY REFERENCE

This application is based upon and claims the benefit of priority from the corresponding Japanese Patent Application No. 2015-236056 filed on Dec. 2, 2015, the entire contents of which are incorporated herein by reference.

### BACKGROUND

The present disclosure relates to an image forming apparatus and an image forming method.

An image forming apparatus, such as a printer, executes a print process in which to print a plurality of images of a plurality of pages in sequence based on image data including the plurality of pages. In this type of image forming apparatus, the print process may be suspended due to some cause such as a paper jam. In that case, the print process is resumed after the cause of the suspension is solved. For example, there is known an image forming apparatus that can resume the print process automatically from a page following a page that had been output immediately before the print process was suspended.

### SUMMARY

An image forming apparatus according to an aspect of the present disclosure includes a control portion. The control portion includes a CPU. The control portion executes a print step, a determination step, a setting step, and a resuming step. In the print step, the control portion executes a print process of printing a plurality of images of a plurality of pages in sequence based on image data including the plurality of pages. In the determination step, the control portion, in a case where the print process executed in the print step has been suspended, determines whether or not a cause of the suspension of the print process is a predetermined particular cause. In the setting step, the control portion, upon determining in the determination step that the cause of the suspension of the print process is not the particular cause, sets a resumption page from which the print process is to be resumed, to a page following a page that had been output immediately before the print process was suspended, and upon determining in the determination step that the cause of the suspension of the print process is the particular cause, sets the resumption page in accordance with a user operation. In the resuming step, the control portion resumes the print process from the resumption page set in the setting step.

An image forming method according to another aspect of the present disclosure includes a first step, a second step, a third step, and a fourth step. In the first step, a print process is executed in which a plurality of images of a plurality of pages are printed in sequence based on image data including a plurality of pages. In the second step, in a case where the print process executed in the first step has been suspended, it is determined whether or not a cause of the suspension of the print process is a predetermined particular cause. In the third step, in a case where it has been determined in the second step that the cause of the suspension of the print process is not the particular cause, a resumption page from which the print process is to be resumed, is set to a page following a page that had been output immediately before the print process was suspended, and in a case where it has been determined in the second step that the cause of the suspension of the print process is the particular cause, the resumption page is set in accordance with a user operation. In the fourth step, the print process is resumed from the resumption page set in the third step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure.

FIG. 2 is a block diagram showing a system configuration of the image forming apparatus according to the embodiment of the present disclosure.

FIG. 3 is a flowchart showing an example of a procedure of a resumption page setting process executed in the image forming apparatus according to the embodiment of the present disclosure.

FIG. 4 is a diagram showing an example of a page setting screen displayed on an operation/display portion of the image forming apparatus according to the embodiment of the present disclosure.

FIG. 5 is a diagram showing an example of a confirmation screen displayed on the operation/display portion of the image forming apparatus according to the embodiment of the present disclosure.

### DETAILED DESCRIPTION

The following describes an embodiment of the present disclosure with reference to the attached drawings for the understanding of the present disclosure. It should be noted that the following embodiment is an example of a specific embodiment of the present disclosure and should not limit the technical scope of the present disclosure.

[Outlined Configuration of Image Forming Apparatus 100]

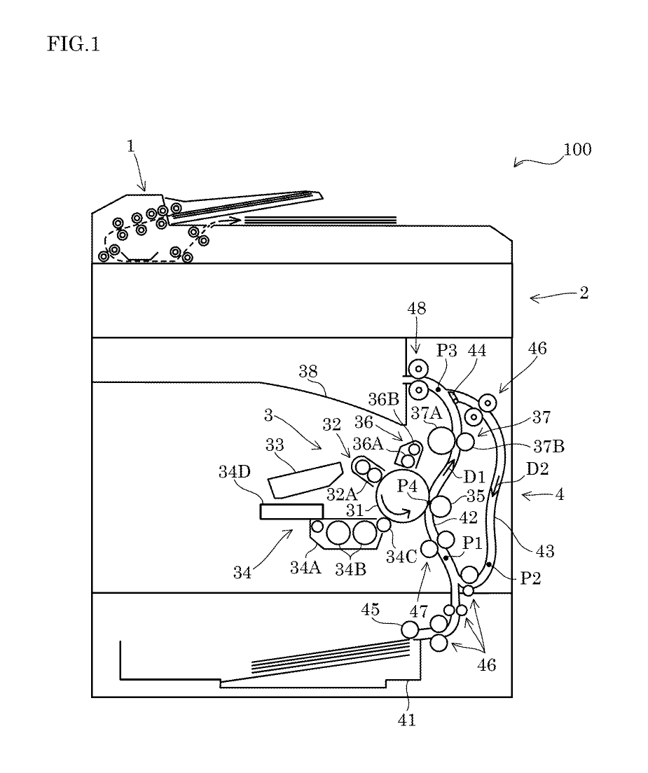

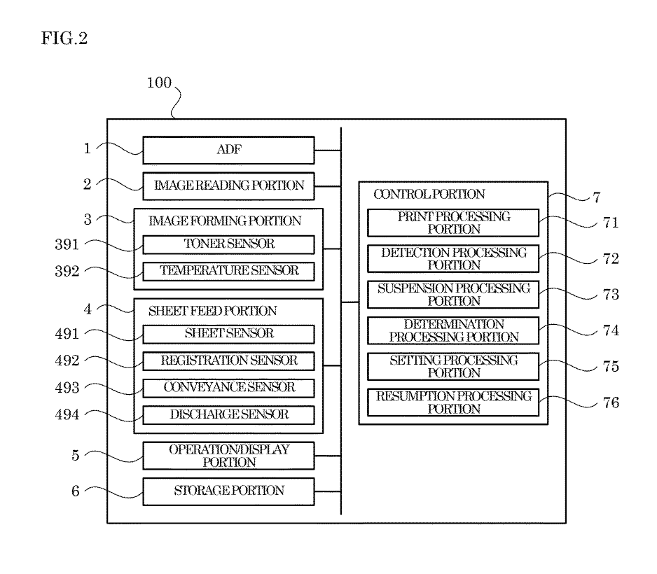

First, an outlined configuration of an image forming apparatus 100 according to an embodiment of the present disclosure is described with reference to FIG. 1 and FIG. 2. Here, FIG. 1 is a schematic cross-sectional view showing the configuration of the image forming apparatus 100.

The image forming apparatus 100 is a multifunction peripheral having a plurality of functions such as a scan function for reading image data from a document sheet, a print function for forming an image based on the image data, a facsimile function, and a copy function. It is noted that the present disclosure is applicable to image forming apparatuses such as a printer device, a facsimile device, and a copier.

Specifically, the image forming apparatus 100 includes an ADF (Auto Document Feeder) 1, an image reading portion 2, an image forming portion 3, a sheet feed portion 4, an operation/display portion 5, a storage portion 6, and a control portion 7.

The ADF 1 is an automatic document feeding device that conveys a document sheet so that it is read by the image reading portion 2. The ADF 1 includes, for example, a document sheet placing portion, a conveyance roller, a document sheet pressing, and a sheet discharge portion.

The image reading portion 2 is configured to read an image from a document sheet and output the read image as image data. The image reading portion 2 includes, for example, a document sheet table, a light source, a mirror, an optical lens, and a CCD (Charge Coupled Device).

The image forming portion 3 is configured to form an image by the electrophotography based on image data read by the image reading portion 2 or input from an external information processing apparatus such as a personal computer.

The sheet feed portion 4 conveys a sheet on which an image is formed by the image forming portion 3.

The operation/display portion 5 includes a display portion and an operation portion. The display portion is, for example, a liquid crystal display and displays information. The operation portion receives user operations. The operation/display portion 5 is, for example, a touch panel that serves as both the display portion and the operation portion. The operation/display portion 5, for example, displays, on the display portion, various types of settings for a print process described below, and receives user operations specifying the settings for the print process.

The storage portion 6 is a nonvolatile storage portion such as a hard disk or an EEPROM. The storage portion 6 stores various control programs that are executed by the control portion 7. In addition, the storage portion 6 stores image data read by the image reading portion 2.

The control portion 7 includes control equipment such as CPU, ROM, and RAM and controls the configurational elements of the image forming apparatus 100. The CPU is a processor that executes various calculation processes. The ROM is a nonvolatile storage portion in which various information such as control programs for causing the CPU to execute various processes are stored in advance. The RAM is a volatile storage portion, and is used as a temporary storage memory (working area) for the various processes executed by the CPU. In the control portion 7, the CPU executes the various control programs stored in the ROM or the storage portion 6.

[Configuration of Image Forming Portion 3 and Sheet Feed Portion 4]

Next, the configuration of the image forming portion 3 and the sheet feed portion 4 is described in detail with reference to FIG. 1 and FIG. 2.

As shown in FIG. 1 and FIG. 2, the image forming portion 3 includes a photoconductor drum 31, a charging device 32, a laser scanning unit (LSU) 33, a developing portion 34, a transfer roller 35, a cleaning device 36, a fixing device 37, a sheet discharge tray 38, a toner sensor 391, and a temperature sensor 392.

On the surface of the photoconductor drum 31, an electrostatic latent image is formed. The photoconductor drum 31 is formed, for example, by coating a surface of a blank tube made of aluminum, with an organic photosensitive material that is composed of an organic compound whose conductivity is improved when light is irradiated. Here, the photoconductor drum 31 is an example of the image carrying member of the present disclosure.

The charging device 32 charges the surface of the photoconductor drum 31. The charging device 32, for example, includes a charging member 32A. The charging member 32A is a roller member provided in contact with the surface of the photoconductor drum 31. A voltage is applied to the charging member 32A from a power source device (not shown). This causes an electric discharge to occur between the charging member 32A and the photoconductor drum 31, and the surface of the photoconductor drum 31 is charged.

The laser scanning unit 33 forms an electrostatic latent image on the surface of the photoconductor drum 31. Specifically, the laser scanning unit 33 irradiates light on the surface of the photoconductor drum 31 charged by the charging member 32A, based on the image data.

The developing portion 34 develops, by using developer, the electrostatic latent image formed on the photoconductor drum 31. The developing portion 34 includes, for example, a developing tank 34A, a stirring member 34B, a developing roller 34C, and a toner container 34D. The developing tank 34A stores the developer that is used to form images. The developer is, for example, two-component developer containing toner and carrier. The stirring member 34B stirs and charges the developer stored in the developing tank 34A. The developing roller 34C supplies the photoconductor drum 31 with the developer charged by the stirring member 34B, thereby forming, on the photoconductor drum 31, a developer image corresponding to the electrostatic latent image. The toner container 34D stores the developer and supplies the developer to the developing tank 34A. Here, the toner container 34D is an example of the developer storage portion of the present disclosure.

The toner sensor 391 is provided in an inside of the developing tank 34A. For example, the toner sensor 391 detects the density of the toner contained in the developer stored in the developing tank 34A. The toner sensor 391 is, for example, a permeability sensor including an LC oscillation circuit that outputs an electric signal corresponding to the permeability of the developer stored in the developing tank 34A. It is noted that the toner sensor 391 may be, for example, an optical sensor that can detect that the remaining amount of the developer stored in the developing tank 34A has become less than a predetermined allowable amount.

The electric signal output from the toner sensor 391 is input to the control portion 7. Upon determining, based on the electric signal output from the toner sensor 391, that the density of the toner stored in the developing tank 34A has become lower than a predetermined allowable value, the control portion 7 causes the toner container 34D to supply the developer.

The transfer roller 35 transfers the developer image formed on the surface of the photoconductor drum 31 by the developing portion 34, to a sheet supplied from the sheet feed portion 4. A voltage is applied to the transfer roller 35 from a power source device (not shown). This allows an electric field to be formed between the transfer roller 35 and the photoconductor drum 31, and the developer image formed on the surface of the photoconductor drum 31 is transferred to the sheet. Here, the transfer roller 35 is an example of the transfer portion of the present disclosure.

The cleaning device 36 cleans the surface of the photoconductor drum 31 after the transfer roller 35 transfers the developer image. For example, the cleaning device 36 includes a cleaning roller 36A and a conveyance screw 36B, wherein the cleaning roller 36A removes developer that remains on the surface of the photoconductor drum 31, and the conveyance screw 36B conveys the developer removed by the cleaning roller 36A to a developer collection container (not shown).

The fixing device 37 heats the developer image transferred to the sheet, thereby fixing the developer image to the sheet. Specifically, as shown in FIG. 1, the fixing device 37 includes a heating roller 37A and a pressure roller 37B. The heating roller 37A is configured to rotate in the heated state. For example, the heating roller 37A is heated to a predetermined fixing temperature by a halogen heater or an IH heater provided in an inside thereof. The pressure roller 37B is configured to rotate while contacting the heating roller 37A. In the fixing device 37, a conveyed sheet is heated by being nipped by the heating roller 37A and the pressure roller 37B. This allows the developer image transferred to the sheet to be fused and fixed to the sheet. It is noted that the heating roller 37A may be a heating belt. Here, the fixing device 37 is an example of the fixing portion of the present disclosure.

The temperature sensor 392 detects the temperature of the fixing device 37. The temperature sensor 392, for example, includes a thermistor that is provided in contact with or not in contact with the surface of the heating roller 37A. The temperature sensor 392 outputs an electric signal corresponding to the surface temperature of the heating roller 37A. It is noted that the temperature sensor 392 may be a contactless infrared sensor that detects the surface temperature of the heating roller 37A.

The electric signal output from the temperature sensor 392 is input to the control portion 7. For example, the control portion 7 performs a temperature control to maintain the temperature of the heating roller 37A to be equal to or higher than the fixing temperature, based on the electric signal output from the temperature sensor 392. Specifically, the temperature sensor 392 performs the temperature control by controlling the driving of the halogen heater or the like.

The sheet discharge tray 38 is a tray onto which sheets are discharged after developer images are fixed thereto by the fixing device 37.

As shown in FIG. 1 and FIG. 2, the sheet feed portion 4 includes a sheet feed cassette 41, a first conveyance path 42, a second conveyance path 43, a switch member 44, a pickup roller 45, a plurality of pairs of conveyance rollers 46, a pair of registration rollers 47, a pair of discharge rollers 48, a sheet sensor 491, a registration sensor 492, a conveyance sensor 493, and a discharge sensor 494.

The sheet feed cassette 41 is loaded with sheets, wherein images are to be formed on the sheets by the image forming portion 3. The sheets loaded on the sheet feed cassette 41 are conveyed to the sheet discharge tray 38 by the sheet feed portion 4.

The first conveyance path 42 is a sheet conveyance path extending from the sheet feed cassette 41 to the sheet discharge tray 38. The first conveyance path 42 is formed by a pair of conveyance guide members provided in a housing of the image forming apparatus 100. As shown in FIG. 1, a plurality of rollers are provided in the first conveyance path 42, wherein the plurality of rollers include the pickup roller 45, the plurality of pairs of conveyance rollers 46, the pair of registration rollers 47, and the pair of discharge rollers 48. In the sheet feed portion 4, a sheet fed from the sheet feed cassette 41 is conveyed along a conveyance direction D1 shown in FIG. 1 by the plurality of rollers as they are rotated upon receiving a driving force transmitted from a motor (not shown).

The second conveyance path 43 is a sheet conveyance path connecting a position located on the downstream side of the fixing device 37 in the first conveyance path 42 in the conveyance direction D1, and a position located on the upstream side of the pair of registration rollers 47 in the conveyance direction D1. The second conveyance path 43 is formed by a pair of conveyance guide members provided in the housing of the image forming apparatus 100. In the second conveyance path 43, the plurality of pairs of conveyance rollers 46 are provided. In the second conveyance path 43, a sheet is conveyed along a conveyance direction D2 shown in FIG. 1 by the pairs of conveyance rollers 46 as they are rotated upon receiving a driving force transmitted from the motor.

The switch member 44 is disposed at a merging point of the first conveyance path 42 and the second conveyance path 43, the merging point being on the downstream side in the first conveyance path 42 in the conveyance direction D1. The switch member 44 is configured to open one of the first conveyance path 42 and the second conveyance path 43, and close the other.

The sheet sensor 491 is located at the sheet feed cassette 41 to detect whether or not a sheet is loaded on the sheet feed cassette 41. The sheet sensor 491 is, for example, a reflection-type optical sensor that includes a light emitting portion and a light receiving portion. In the sheet sensor 491, when a sheet is loaded on the sheet feed cassette 41, light emitted from the light emitting portion is reflected on the sheet, and irradiated on the light receiving portion. This allows the sheet sensor 491 to output an electric signal corresponding to whether or not a sheet is loaded on the sheet feed cassette 41. It is noted that the sheet sensor 491 may be another type of sensor such as a transmission-type optical sensor or an ultrasonic sensor as far as it can detect a sheet loaded on the sheet feed cassette 41.

The registration sensor 492 detects a front-end portion of a sheet passing a first position P1 (see FIG. 1) located on the upstream side of the pair of registration rollers 47 in the first conveyance path 42 in the conveyance direction D1. The registration sensor 492 is, for example, a transmission-type optical sensor including a light emitting portion and a light receiving portion that are respectively disposed on the pair of conveyance guide members. In the registration sensor 492, an electric signal is output from the light receiving portion, the electric signal representing presence or absence of a sheet passing through between the light emitting portion and the light receiving portion. The electric signal output from the registration sensor 492 is input to the control portion 7. It is noted that the registration sensor 492 may be of any other type as far as it can detect a passage of a front-end portion of a sheet.

One or more conveyance sensors 493 are disposed in the first conveyance path 42 and the second conveyance path 43 so as to detect a passage of a sheet. In the present embodiment, the conveyance sensor 493 detects a passage of a sheet at a second position P2 in the second conveyance path 43 indicated in FIG. 1. The conveyance sensor 493 is, for example, a transmission-type optical sensor including a light emitting portion and a light receiving portion that are respectively disposed on the pair of conveyance guide members, as is the case with the registration sensor 492. In the conveyance sensor 493, an electric signal is output from the light receiving portion, the electric signal representing presence or absence of a sheet passing through between the light emitting portion and the light receiving portion. The electric signal output from the conveyance sensor 493 is input to the control portion 7. It is noted that the conveyance sensor 493 may be of any other type as far as it can detect a passage of a sheet.

The discharge sensor 494 detects a rear-end portion of a sheet passing a third position P3 (see FIG. 1) located on the downstream side of the switch member 44 in the first conveyance path 42 in the conveyance direction D1. The discharge sensor 494 is, for example, a transmission-type optical sensor including a light emitting portion and a light receiving portion that are respectively disposed on the pair of conveyance guide members, as is the case with the registration sensor 492. In the discharge sensor 494, an electric signal is output from the light receiving portion, wherein the electric signal representing presence or absence of a sheet passing through between the light emitting portion and the light receiving portion. The electric signal output from the discharge sensor 494 is input to the control portion 7. It is noted that the discharge sensor 494 may be of any other type as far as it can detect a passage of a rear-end portion of a sheet.

In the image forming portion 3, an image is formed on a sheet supplied from the sheet feed portion 4, in the following procedure. It is noted that the sheet is a sheet of paper, a sheet of coated paper, a postcard, an envelope, an OHP sheet or the like.

First, the charging device 32 charges the surface of the photoconductor drum 31 uniformly to a certain potential. The laser scanning unit 33 then irradiates a light beam on the surface of the photoconductor drum 31 based on the image data. This allows an electrostatic latent image corresponding to the image data to be formed on the surface of the photoconductor drum 31.

The electrostatic latent image formed on the surface of the photoconductor drum 31 is developed (visualized) as a developer image by the developing portion 34. The developer image developed by the developing portion 34 is conveyed by the photoconductor drum 31 rotating in a direction indicated by an arrow in FIG. 1, to a transfer position (image formation position P4) at which the developer image is transferred by the transfer roller 35.

On the other hand, in parallel to the image formation operation of the image forming portion 3, the sheet feed portion 4 feeds a sheet to the image formation position P4. For example, the sheet feed portion 4 uses a lift plate (not shown) provided in a bottom portion of the sheet feed cassette 41 to lift the sheets loaded on the sheet feed cassette 41 to a contact position where a top-most sheet contacts the pickup roller 45. The pickup roller 45 picks up the top-most sheet at the contact position. The sheet picked up by the pickup roller 45 is conveyed by the conveyance rollers 46 to a position where the pair of registration rollers 47 are disposed.

The pair of registration rollers 47 send the sheet toward the image formation position P4 such that the sheet reaches the image formation position P4 at the same timing when the developer image carried by the rotating photoconductor drum 31 reaches the image formation position P4. For example, the control portion 7 sets a timing at which the pair of registration rollers 47 send the sheet so that the arrival timing of the sheet matches the arrival timing of the developer image, based on a timing at which a passage of a front portion of the sheet was detected by the registration sensor 492. The pair of registration rollers 47 send the sheet toward the image formation position P4 based on the timing set by the control portion 7. This allows both the sheet and the developer image to reach the image formation position P4 at the same timing, and the developer image is transferred to the surface of the sheet at the image formation position P4.

The sheet to which the developer image was transferred at the image formation position P4 is sent to the fixing device 37 by the rotation of the photoconductor drum 31 and the transfer roller 35. In the fixing device 37, the developer image transferred to the sheet is heated and pressed by the heating roller 37A and the pressure roller 37B. This allows the developer image to be fused and fixed to the sheet. The sheet to which the developer image was fixed by the fixing device 37 is discharged to the sheet discharge tray 38 by the pair of discharge rollers 48. It is noted that the developer that has remained on the surface of the photoconductor drum 31 after the transfer of the developer image by the transfer roller 35, is removed by the cleaning device 36.

In the image forming apparatus 100, printing can be made on both sides of a sheet conveyed in the sheet feed portion 4. Specifically, in the both-side printing, the control portion 7 causes the switch member 44 to close the first conveyance path 42 and open the second conveyance path 43 immediately after the discharge sensor 494 detected a passage of a rear-end portion of a sheet. Subsequently, after the second conveyance path 43 is opened, the control portion 7 causes the pair of discharge rollers 48 to rotate in a reverse direction. This allows the sheet to be sent to the second conveyance path 43. In the second conveyance path 43, the sheet is conveyed to the merging point of the first conveyance path 42 and the second conveyance path 43, and from the merging point, the sheet is conveyed in a state where the front side and the rear side of the sheet are reversed. This allows an image to be formed on the rear side of the sheet.

As shown in FIG. 2, the control portion 7 includes a print processing portion 71, a detection processing portion 72, and a suspension processing portion 73. Specifically, the control portion 7 functions as the print processing portion 71, the detection processing portion 72, and the suspension processing portion 73 when it executes the control programs.

The print processing portion 71 executes a print process in which a plurality of images of a plurality of pages are printed in sequence based on image data that includes the plurality of pages. Specifically, the print processing portion 71 executes the print process by using the image forming portion 3 and the sheet feed portion 4.

For example, when an operation is performed on the operation/display portion 5 to execute a copy process for copying a document sheet placed on the document sheet table of the ADF 1, the print processing portion 71 executes an image reading process of reading the plurality of images of the plurality of pages from the document sheet by using the ADF 1 and the image reading portion 2. The print processing portion 71 executes the print process based on the image data read in the image reading process. In addition, in a case where an instruction instructing to execute the print process has been received together with image data from an external information processing apparatus, the print processing portion 71 executes the print process based on the received image data.

The detection processing portion 72, while the print process is executed by the print processing portion 71, detects an occurrence of a predetermined abnormality, which causes the print process to be suspended.

For example, the abnormality includes an exhaustion of the developer stored in the toner container 34D. For example, the detection processing portion 72 determines that the developer exhaustion has occurred when the density of the toner stored in the developing tank 34A has become lower than the predetermined allowable value, and the density of the toner stored in the developing tank 34A does not increase even after a predetermined supply time period elapses while the toner container 34D is expected to be supplying the developer. It is noted that the detection processing portion 72 may calculate consumption of developer based on the printing rate of image data during the print process, and detect a developer exhaustion based on the results of comparison between a cumulative value of the calculated consumption of developer and an initial amount of developer stored in the toner container 34D.

The abnormality also includes a temperature control abnormality in the fixing device 37. For example, the detection processing portion 72 determines that a temperature control abnormality has occurred when the temperature of the heating roller 37A of the fixing device 37 detected by the temperature sensor 392 has become lower than a predetermined lower limit temperature that is lower than the fixing temperature, in spite of a temperature control being performed. In addition, the detection processing portion 72 may determine that a temperature control abnormality has occurred when the temperature of the heating roller 37A has continued to be lower than the fixing temperature for more than a predetermined allowable time period, in spite of a temperature control being performed.

The abnormality also includes a sheet exhaustion where the sheets loaded on the sheet feed cassette 41 are exhausted. For example, the detection processing portion 72 determines that a sheet exhaustion has occurred when a sheet is not detected by the sheet sensor 491.

The abnormality also includes a paper jam where paper is clogged in the first conveyance path 42 or the second conveyance path 43. For example, the detection processing portion 72 detects a paper jam in the first conveyance path 42 or the second conveyance path 43 by using the registration sensor 492, the conveyance sensor 493, and the discharge sensor 494. For example, the detection processing portion 72 determines that a paper jam has occurred in a section on the upstream side of the registration sensor 492 in the conveyance direction when a sheet is not detected by the registration sensor 492 within a predetermined conveyance time period from a start of conveyance of the sheet by the sheet feed portion 4. It is noted that the detection processing portion 72 may determine that a paper jam has occurred when an excessive current exceeding an allowable range flows through the motor that transmits a driving force to the pair of registration rollers 47, the plurality of pairs of conveyance rollers 46, or the pair of discharge rollers 48.

It is noted that the abnormality detected by the detection processing portion 72 is not limited to the developer exhaustion, the temperature control abnormality, the sheet exhaustion, and the paper jam described above, but may be another abnormality that would cause the print process to be suspended.

The suspension processing portion 73 suspends the print process when the detection processing portion 72 detects an abnormality during an execution of the print process.

For example, upon detection of the abnormality, namely, the developer exhaustion, the temperature control abnormality, or the sheet exhaustion by the detection processing portion 72, the suspension processing portion 73 suspends the print process by stopping the operation of the image forming portion 3 and the sheet feed portion 4, after a printing of forming an image on a sheet that was being conveyed by the sheet feed portion 4 when the abnormality was detected, is completed. In addition, the suspension processing portion 73 stores output page information in a predetermined output page storage area of the RAM, wherein the output page information indicates a page that had been output last before the print process was suspended.

When the detection processing portion 72 detects a paper jam, the suspension processing portion 73 suspends the print process by immediately stopping the operation of the image forming portion 3 and the sheet feed portion 4. In addition, the suspension processing portion 73 stores output page information in the output page storage area of the RAM, wherein the output page information indicates a page that had been output last before the print process was suspended.

The suspension processing portion 73 suspends the print process when a suspension instruction to suspend the print process is input during an execution of the print process. For example, the suspension instruction is input to the control portion 7 in response to a user operation performed on the operation/display portion 5. The suspension instruction may be transmitted from an external information processing apparatus to the image forming apparatus 100 and input to the control portion 7. Here, the user operation corresponding to the input of the suspension instruction is an example of the operation instructing to suspend the print process, of the present disclosure.

For example, when the suspension instruction to suspend the print process is input, the suspension processing portion 73 suspends the print process by stopping the operation of the image forming portion 3 and the sheet feed portion 4 after a printing on a sheet that was being conveyed by the sheet feed portion 4 when the suspension instruction to suspend the print process was input, is completed. In addition, the suspension processing portion 73 stores output page information in the output page storage area of the RAM, wherein the output page information indicates a page that had been output last before the print process was suspended.

It is noted here that in the image forming apparatus 100, the print process may be suspended due to some reason, other than by the suspension processing portion 73. For example, in the image forming apparatus 100, the print process is suspended when a connection between the image forming apparatus 100 and an external commercial power source is interrupted due to a power failure.

For example, the image forming apparatus 100 includes a detection circuit (not shown) configured to detect whether or not power is supplied from the external commercial power source. The control portion 7 detects, by using the detection circuit, an interruption of the connection between the image forming apparatus 100 and the external commercial power source. In addition, when an interruption of the connection with the external commercial power source is detected during an execution of the print process, the suspension processing portion 73 stores processing status information in a predetermined processing status storage area of the EEPROM before the operation of the image forming apparatus 100 stops, wherein the processing status information indicates the processing status of the print process at the time when the interruption of the connection with the external commercial power source was detected.

Meanwhile, according to a conventional image forming apparatus, when the print process is suspended due to a detection of some abnormality, the print process is resumed after the abnormality is solved. For example, according to the conventional image forming apparatus, the print process is automatically resumed from a page following a page that had been output immediately before the print process was suspended.

It is noted here that resuming the print process from a page following a page that had been output immediately before the print process was suspended, may not match the intention of the user. For example, in a case where the print process was suspended due to a developer exhaustion, the print density may have been degraded in one or more prints that had been output immediately before the print process was suspended. In that case, the user may desire to resume the print process from a page on which degradation of the print density is recognized, not from a page following a page that had been output immediately before the print process was suspended. With regard to this problem, one may consider a configuration where the resumption page, from which the print process is resumed, is always set in accordance with a user operation in response to a suspension of the print process. However, in the case where the resumption page is always set in accordance with a user operation, the user is forced to perform an operation for setting the resumption page even when the print process is suspended due to a paper jam or the like.

On the other hand, as described below, the image forming apparatus 100 is configured to resume the print process from a page that matches the user's intention, without unnecessarily increasing troublesome user operation.

Specifically, in the image forming apparatus 100, the resumption page is set in accordance with a user operation only when the print process is suspended due to a predetermined particular cause.

For example, in the image forming apparatus 100, the developer exhaustion is set as the particular cause. As a result, when the print process is suspended due to the developer exhaustion, the resumption page is set in accordance with a user operation.

It is also noted that in the image forming apparatus 100, in a case where the print process is suspended due to a temperature control abnormality, the developer may have been peeled off from one or more prints that had been discharged to the sheet discharge tray 38 immediately before the print process was suspended, due to insufficient heating in the fixing device 37. In that case, the user may desire to resume the print process from a page on which a peel-off of the developer is recognized. As a result, in the image forming apparatus 100, the temperature control abnormality is set as the particular cause, and when the print process is suspended due to the temperature control abnormality, the resumption page is set in accordance with a user operation.

It is also noted that in the image forming apparatus 100, an inside of the image forming apparatus 100 may be smeared by the developer, and a smear may be recognized on one or more prints discharged to the sheet discharge tray 38. In that case, the user may desire to suspend the print process once, clean the inside of the image forming apparatus 100, and then resume the print process from a page on which the smear is recognized. As a result, in the image forming apparatus 100, an input of the suspension instruction is set as the particular cause, and when the print process is suspended due to the input of the suspension instruction, the resumption page is set in accordance with a user operation.

It is also noted that in the image forming apparatus 100, in a case where the processing status information is stored in the processing status storage area of the EEPROM when the image forming apparatus 100 is powered on, a discharge process is executed to discharge a sheet that is present in the first conveyance path 42 or the second conveyance path 43, to the sheet discharge tray 38. Subsequently, after the discharge process, the print process is resumed from a page following a page that had been output immediately before the interruption of the connection between the image forming apparatus 100 and the external commercial power source was detected. Here, there may be a case where, on the sheet discharged in the discharge process, a printing had already been made before the print process was suspended. In that case, the user may desire to resume the print process from a page following a page that corresponds to the sheet discharged in the discharge process. As a result, in the image forming apparatus 100, the interruption of the connection between the image forming apparatus 100 and the external commercial power source is set as the particular cause, and when the print process is suspended due to the interruption of the connection with the external commercial power source, the resumption page is set in accordance with a user operation.

It is noted that the particular cause may be arbitrarily set from the above-described causes that suspend the print process, in accordance with a user operation performed on the operation/display portion 5.

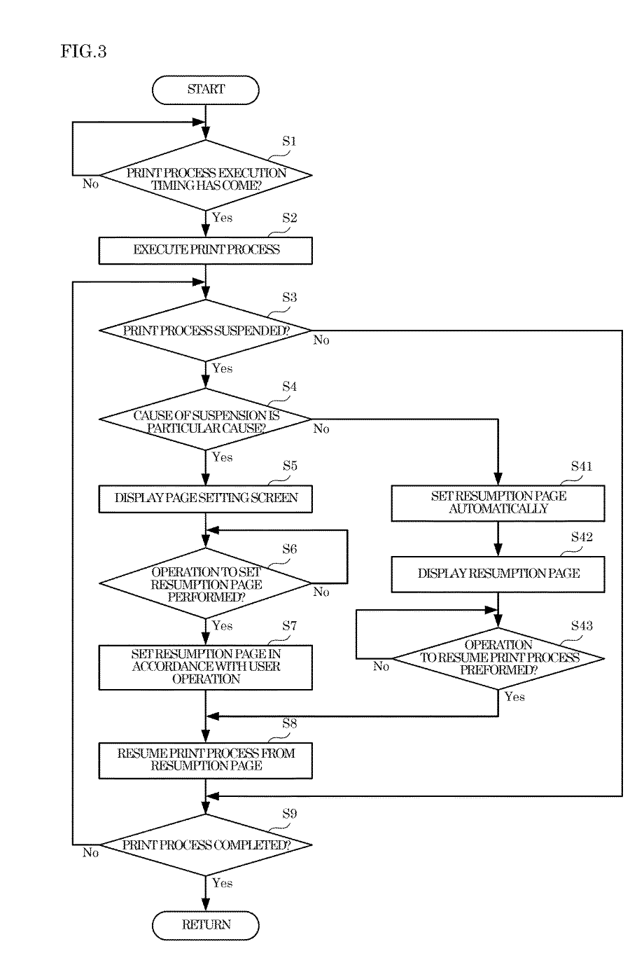

On the other hand, in the ROM of the control portion 7, a resumption page setting program is stored in advance, wherein the resumption page setting program causes the CPU to execute a resumption page setting process (see the flowchart of FIG. 3) described below. It is noted that the resumption page setting program may be recorded on a computer-readable recording medium such as a CD, a DVD, or a flash memory, and read from the recording medium and installed into the storage portion 6.

As shown in FIG. 2, the control portion 7 further includes a determination processing portion 74, a setting processing portion 75, and a resumption processing portion 76. Specifically, the control portion 7 executes the resumption page setting program stored in the ROM by using the CPU. This allows the control portion 7 to function as the determination processing portion 74, the setting processing portion 75, and the resumption processing portion 76.

The determination processing portion 74, when the print process executed by the print processing portion 71 has been suspended, determines whether or not the cause of the suspension of the print process is the particular cause.

For example, when the print process has been suspended by the suspension processing portion 73, the determination processing portion 74 determines whether or not the cause of the suspension is the particular cause. Here, the cause of the suspension includes a detection of abnormality by the detection processing portion 72 and an input of the suspension instruction to suspend the print process to the control portion 7.

In addition, when the print process is suspended due to the interruption of the connection between the image forming apparatus 100 and the external commercial power source, the determination processing portion 74 determines whether or not the cause of the suspension is the particular cause. That is, the cause of the suspension includes an interruption of the connection between the image forming apparatus 100 and the external commercial power source.

For example, each time the image forming apparatus 100 is powered on, the control portion 7 confirms whether or not the processing status information is stored in the processing status storage area of the EEPROM. Upon confirming that the processing status information is stored in the processing status storage area of the EEPROM, the control portion 7 determines that the print process has been suspended, and determines whether or not the cause of the suspension, namely, the interruption of the connection between the image forming apparatus 100 and the external commercial power source, is the particular cause.

When the determination processing portion 74 determines that the cause of the suspension is not the particular cause, the setting processing portion 75 sets the resumption page from which the print process is resumed, to a page following a page that had been output immediately before the print process was suspended.

For example, the setting processing portion 75 identifies the page following the page that had been output immediately before the print process was suspended, based on the output page information stored in the output page storage area of the RAM. The setting processing portion 75 then sets the resumption page by storing resumption page information in a predetermined resumption page storage area of the RAM, wherein the resumption page information indicates a page number of the identified page.

It is noted that in the image forming apparatus 100, there may be a case where the interruption of the connection between the image forming apparatus 100 and the external commercial power source is not set as the particular cause by a user operation. In this case, when the print process is suspended due to an interruption of the connection between the image forming apparatus 100 and the external commercial power source, the setting processing portion 75 identifies the page following the page that had been output immediately before the print process was suspended, based on the processing status information stored in the processing status storage area of the EEPROM.

When the determination processing portion 74 determines that the cause of the suspension is the particular cause, the setting processing portion 75 sets the resumption page in accordance with a user operation.

For example, when the determination processing portion 74 determines that the cause of the suspension is the particular cause, the setting processing portion 75 displays a page setting screen on the operation/display portion 5, wherein the page setting screen includes one or more preview images of pages that are candidates for the resumption page. The user, upon viewing the page setting screen, selects a preview image from the preview images displayed on the page setting screen. The setting processing portion 75 sets the resumption page to a page that corresponds to the preview image selected by the user. This makes it possible to save time and effort of the user in finding, from the prints discharged to the sheet discharge tray 38, a page number of a page that the user would like to specify as the resumption page.

In addition, the setting processing portion 75 changes the preview images included in the page setting screen in accordance with a user operation performed on the page setting screen. This makes it possible to secure a wide display area to each preview image by reducing the number of preview images displayed on one screen, allowing the user to easily confirm the contents of the preview images.

For example, the setting processing portion 75 sets the resumption page by storing the resumption page information that indicates a page number of the page that was specified by a user operation as the resumption page, in the resumption page storage area of the RAM.

It is noted that when the determination processing portion 74 determines that the cause of the suspension is the particular cause, the setting processing portion 75 may display a message urging the user to confirm the prints output to the sheet discharge tray 38. For example, the setting processing portion 75 may display the message on the page setting screen. With this configuration, in a case where the print process has been suspended due to the developer exhaustion and the print density of the prints output to the sheet discharge tray 38 has been degraded, the user can recognize that the print density of the prints has been degraded.

The resumption processing portion 76 resumes the print process from the resumption page set by the setting processing portion 75.

For example, the resumption processing portion 76 resumes the print process from the page (the resumption page) indicated by the resumption page information stored in the resumption page storage area of the RAM.

Here, when the determination processing portion 74 determines that the cause of the suspension is not the particular cause, the resumption processing portion 76 displays a confirmation screen on the operation/display portion 5, wherein the confirmation screen includes a preview image of the resumption page set by the setting processing portion 75, and resumes the print process in accordance with a user operation performed on the confirmation screen. This makes it possible to prevent the print process to be resumed automatically without the user's confirmation on the resumption page, preventing the user from doubting that the print process might be resumed from a page that is different from the page following the page that had been output immediately before the print process was suspended.

[Resumption Page Setting Process]

In the following, with reference to FIG. 3, a description is given of an example of the procedure of the resumption page setting process executed by the control portion 7 in the image processing apparatus 100. Here, steps S1, S2, . . . represent numbers assigned to the processing procedures (steps) executed by the control portion 7.

<Step S1>

In step S1, the control portion 7 determines whether or not execution timing for executing the print process has come. For example, the control portion 7 determines that the execution timing for executing the print process has come when an operation instructing to execute the copy process has been performed, wherein in the copy process, a document sheet placed on the document sheet table of the ADF 1 is copied. In addition, the control portion 7 determines that the execution timing for executing the print process has come when an instruction instructing to execute the print process has been received from the external information processing apparatus together with image data.

Here, upon determining that the execution timing for executing the print process has not come (S1: No), the control portion 7 causes the process to wait at step S1 until it determines that the execution timing for executing the print process has come. On the other hand, upon determining that the execution timing for executing the print process has come (S1: Yes), the control portion 7 moves the process to step S2.

<Step S2>

In step S2, the control portion 7 executes the print process. In the print process, the control portion 7 prints a plurality of images of a plurality of pages in sequence based on the image data that includes the plurality of pages. Here, the process of step S2 is an example of the first step of the present disclosure, and is executed by the print processing portion 71 of the control portion 7.

For example, upon detecting, in step S1, an input of an operation instructing to execute the copy process, the control portion 7 executes the image reading process of reading the images of the pages from the document sheet by using the ADF 1 and the image reading portion 2. The control portion 7 executes the print process based on the image data read in the image reading process.

In addition, upon detecting, in step S1, a reception of an instruction instructing to execute the print process from the external information processing apparatus together with image data, the control portion 7 executes the print process based on the image data received from the external information processing apparatus.

<Step S3>

In step S3, the control portion 7 determines whether or not the print process has been suspended.

For example, the control portion 7 determines that the print process has been suspended in a case where the print process has been suspended by the suspension processing portion 73.

In addition, the control portion 7 determines that the print process has been suspended in a case where the print process has been suspended due to an interruption of a connection between the image forming apparatus 100 and the external commercial power source. Specifically, in this case, the execution of the resumption page setting process is also suspended in step S3 due to the interruption of the connection between the image forming apparatus 100 and the external commercial power source. In addition, the execution of the resumption page setting process may be suspended in step S1 due to the interruption of the connection between the image forming apparatus 100 and the external commercial power source. As a result, when the image forming apparatus 100 is powered on, the control portion 7 determines whether or not the processing status information is stored in the processing status storage area of the EEPROM. Upon determining that the processing status information is stored in the processing status storage area of the EEPROM, the control portion 7 resumes the execution of the resumption page setting process from step S3, and determines that the print process has been suspended. On the other hand, upon determining that the processing status information is not stored in the processing status storage area of the EEPROM, the control portion 7 resumes the execution of the resumption page setting process from step S1.

Here, upon determining that the print process has been suspended (S3: Yes), the control portion 7 moves the process to step S4, and upon determining that the print process has not been suspended (S3: No), the control portion 7 moves the process to step S9.

<Step S4>

In step S4, the control portion 7 determines whether or not the cause of the suspension of the print process is the particular cause. Here, the processes of step S3 and step S4 are an example of the second step of the present disclosure, and are executed by the determination processing portion 74 of the control portion 7.

Here, upon determining that the cause of the suspension of the print process is the particular cause (S4: Yes), the control portion 7 moves the process to step S5, and upon determining that the cause of the suspension of the print process is not the particular cause (S4: No), the control portion 7 moves the process to step S41.

<Step S5>

In step S5, the control portion 7 displays the page setting screen on the operation/display portion 5, and receives a user operation to set the resumption page. It is noted that, in a case where the print process has been suspended due to a detection of some abnormality, the control portion 7 displays the page setting screen after the abnormality is solved.

Here, in the image forming apparatus 100, the developer exhaustion has been set as the particular cause. As a result, in the resumption page setting process, the page setting screen is displayed when the print process has been suspended due to the developer exhaustion. This makes it possible, in the case where the print density has been degraded in one or more prints that had been output immediately before the print process was suspended, for the user to resume the print process from a page on which degradation of the print density is recognized.

In addition, in the image forming apparatus 100, the temperature control abnormality has been set as the particular cause. As a result, in the resumption page setting process, the page setting screen is displayed when the print process has been suspended due to the temperature control abnormality. This makes it possible, in the case where a peel-off of the developer is recognized on one or more prints that had been output immediately before the print process was suspended, for the user to resume the print process from a page on which a peel-off of the developer is recognized.

In addition, in the image forming apparatus 100, an input of the suspension instruction has been set as the particular cause. As a result, in the resumption page setting process, the page setting screen is displayed when the print process has been suspended due to the input of the suspension instruction. This makes it possible, in the case where a smear is recognized on one or more prints that had been output immediately before the print process was suspended, for the user to resume the print process from a page on which the smear is recognized.

In addition, in the image forming apparatus 100, the interruption of the connection between the image forming apparatus 100 and the external commercial power source has been set as the particular cause. As a result, in the resumption page setting process, the page setting screen is displayed when the print process has been suspended due to the interruption of the connection between the image forming apparatus 100 and the external commercial power source. This makes it possible, in the case where the printing has been completed on the sheet discharged in the discharge process, for the user to resume the print process from a page following the page corresponding to the discharged sheet.

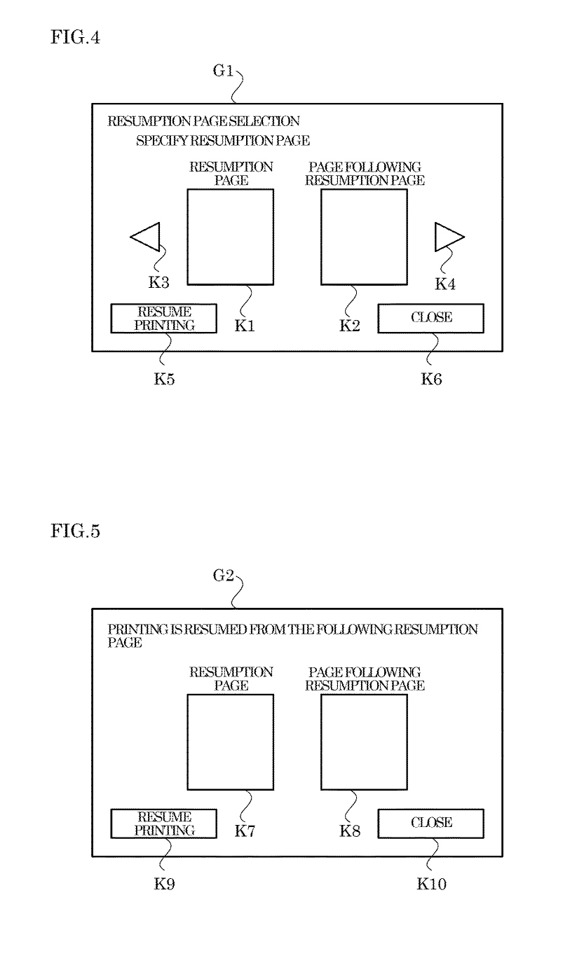

Here, FIG. 4 shows an example of the page setting screen displayed on the operation/display portion 5 in step S5 by the control portion 7. A page setting screen G1 shown in FIG. 4 includes a first display area K1, a second display area K2, and operation keys K3 to K6.

In the first display area K1 and the second display area K2, preview images of pages to be printed in the print process are displayed. For example, in the first display area K1, a preview image of a page following a page that had been output immediately before the print process was suspended, is displayed. In addition, in the second display area K2, a preview image of a page following the page displayed in the first display area K1, is displayed. For example, the control portion 7 identifies the page following the page that had been output immediately before the print process was suspended, based on the output page information stored in the output page storage area of the RAM.

The operation keys K3 and K4 are operated to change the pages displayed in the first display area K1 and the second display area K2. For example, each time the operation key K3 is operated, the control portion 7 reduces, by one, each page number of the pages displayed in the first display area K1 and the second display area K2. In addition, each time the operation key K4 is operated, the control portion 7 increases, by one, each page number of the pages displayed in the first display area K1 and the second display area K2.

The operation key K5 is operated so as to set the resumption page. For example, when the operation key K5 is operated, the control portion 7 sets the resumption page to the page displayed on the first display area K1. The operation key K6 is operated so as to cancel the print process.

It is noted that the control portion 7 may display, on the page setting screen, a message urging the user to confirm the prints output to the sheet discharge tray 38. This makes it possible, in the case where the print process has been suspended due to the developer exhaustion, to urge the user to confirm whether or not the prints discharged to the sheet discharge tray 38 are degraded in print density. In addition, this makes it possible, in the case where the print process has been suspended due to the temperature control abnormality, to urge the user to confirm whether or not a peel-off of the developer transferred to the prints on the sheet discharge tray 38, is recognized. In addition, this makes it possible, in the case where the print process has been suspended due to the interruption of the connection between the image forming apparatus 100 and the external commercial power source, to urge the user to confirm whether or not a printing on the sheet discharged to the sheet discharge tray 38 during the discharge process, is completed.

In addition, the control portion 7 may display, in place of the page setting screen, a screen for receiving an input operation of a page number of the resumption page, on the operation/display portion 5.

<Step S6>

In step S6, the control portion 7 determines whether or not a user operation to set the resumption page has been performed on the page setting screen displayed in step S5. For example, when the operation key K5 has been operated on the page setting screen G1, the control portion 7 determines that a user operation to set the resumption page has been performed.

Here, upon determining that a user operation to set the resumption page has not been performed (S6: No), the control portion 7 causes the process to wait at step S6 until it determines that a user operation to set the resumption page has been performed. On the other hand, upon determining that a user operation to set the resumption page has been performed (S6: Yes), the control portion 7 moves the process to step S7.

It is noted that in step S6, when the operation key K6 has been operated on the page setting screen G1, the control portion 7 determines that the print process was cancelled. In this case, the control portion 7 moves the process to step S1, and causes the process to wait until the next timing for executing the print process comes.

<Step S7>

In step S7, the control portion 7 sets the resumption page in accordance with a user operation received on the page setting screen. For example, when the operation key K5 has been operated on the page setting screen G1, the control portion 7 sets the resumption page by storing, in the resumption page storage area of the RAM, the resumption page information that indicates a page number of a page displayed on the first display area K1.

<Step S41>

On the other hand, the process of step S41 is executed when, in step S4, the control portion 7 determines that the cause of the suspension of the print process is not the particular cause. In step S41, the control portion 7 sets the resumption page from which the print process is resumed, to a page following a page that had been output immediately before the print process was suspended. Here, the processes of steps S5, S6, S7 and S41 are an example of the third step of the present disclosure, and is executed by the setting processing portion 75 of the control portion 7.

For example, the control portion 7 identifies the page following the page that had been output immediately before the print process was suspended, based on the output page information stored in the output page storage area of the RAM. The control portion 7 then sets the resumption page by storing the resumption page information indicating a page number of the identified page, in the resumption page storage area of the RAM.

<Step S42>

In step S42, the control portion 7 displays, on the operation/display portion 5, the confirmation screen including a preview image of the page set as the resumption page in step S41. It is noted that in a case where the print process has been cancelled due to a detection of some abnormality, the control portion 7 displays the confirmation screen after the abnormality is solved.

Here, FIG. 5 shows an example of the confirmation screen displayed on the operation/display portion 5 in step S42 by the control portion 7. A confirmation screen G2 shown in FIG. 5 includes a third display area K7, a fourth display area K8, and operation keys K9 and K10.

In the third display area K7, a preview image of the page that was set as the resumption page in step S41 is displayed. In addition, in the fourth display area K8, a preview image of a page following the page that was set as the resumption page in step S41 is displayed. The operation key K9 is operated so as to resume the print process. The operation key K10 is operated so as to cancel the print process.

<Step S43>

In step S43, the control portion 7 determines whether or not a user operation to resume the print process has been performed. For example, when the operation key K9 has been operated on the confirmation screen G2, the control portion 7 determines that a user operation instructing to resume the print process has been performed.

Here, upon determining that a user operation instructing to resume the print process has not been performed (S43: No), the control portion 7 causes the process to wait at step S43 until it determines that a user operation instructing to resume the print process has been performed. On the other hand, upon determining that a user operation instructing to resume the print process has been performed (S43: Yes), the control portion 7 moves the process to step S8.

It is noted that in step S43, when the operation key K10 has been operated on the confirmation screen G2, the control portion 7 determines that the print process was cancelled. In this case, the control portion 7 moves the process to step S1, and causes the process to wait until the next timing for executing the print process comes.

It is noted that the processes of steps S42 and S43 may be omitted.

<Step S8>

In step S8, the control portion 7 resumes the print process from the page that was set as the resumption page in step S7 or step S41. Here, the process of step S8 is an example of the fourth step of the present disclosure, and is executed by the resumption processing portion 76 of the control portion 7.

For example, the control portion 7 resumes the print process from the resumption page that is indicated by the resumption page information stored in the resumption page storage area of the RAM.

<Step S9>

In step S9, the control portion 7 determines whether or not the print process is completed. For example, when all pages included in the image data have been printed, the control portion 7 determines that the print process is completed. It is noted that when a cancellation operation to cancel the print process is performed during the execution of the print process, the control portion 7 may determine that the print process is completed.

Here, upon determining that the print process is completed (S9: Yes), the control portion 7 moves the process to step S1, and waits for the next timing for executing the print process to come. On the other hand, upon determining that the print process is not completed (S9: No), the control portion 7 returns the process to step S3, and waits for a suspension of the print process until it determines that the print process is completed.

As described above, in the image forming apparatus 100, when the determination processing portion 74 determines that the cause of the suspension is the particular cause, the resumption page is set in accordance with a user operation. As a result, in the image forming apparatus 100, it is possible to resume the print process from a page that matches the intention of the user.

On the other hand, in the image forming apparatus 100, when the determination processing portion 74 determines that the cause of the suspension is not the particular cause, the resumption page is set to a page following a page that had been discharged to the sheet discharge tray 38 immediately before the print process was suspended. With this configuration, in the image forming apparatus 100, it is possible to prevent troublesome user operation from being increased unnecessarily.

It is noted that the image forming apparatus and the image forming method according to the present disclosure are not limited to an electrophotographic image forming apparatus and an electrophotographic image forming method, but are applicable to image forming apparatuses and image forming methods using other image forming systems such as the ink jet system.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a control portion including a CPU,
the control portion executing:
a print step of executing a print process in which a plurality of images of a plurality of pages are printed in sequence based on image data including a plurality of pages;
a determination step of, in a case where the print process executed in the print step has been suspended, determining whether or not a cause of the suspension of the print process is a predetermined particular cause;
a setting step of, in a case where it has been determined in the determination step that the cause of the suspension of the print process is not the particular cause, setting a resumption page from which the print process is to be resumed, to a page following a page that had been output immediately before the print process was suspended, and in a case where it has been determined in the determination step that the cause of the suspension of the print process is the particular cause, setting the resumption page in accordance with a user operation; and
a resuming step of resuming the print process from the resumption page set in the setting step.

2. The image forming apparatus according to claim 1, further comprising:
a developer storage portion configured to store developer used in the print process, wherein
the particular cause includes a developer exhaustion where the developer stored in the developer storage portion is exhausted.

3. The image forming apparatus according to claim 1, further comprising:
an image carrying member on which an electrostatic latent image is formed;
a developing portion configured to develop, by using toner, the electrostatic latent image formed on the image carrying member;
a transfer portion configured to transfer a toner image formed on the image carrying member by the developing portion, from the image carrying member to a sheet; and
a fixing portion configured to fix the toner image transferred to the sheet, to the sheet by heating the toner image, wherein
the particular cause includes a case where a temperature of the fixing portion is lower than a predetermined lower limit temperature.

4. The image forming apparatus according to claim 1, wherein
the particular cause includes a case where a user has performed an operation instructing to suspend the print process.

5. The image forming apparatus according to claim 1, wherein
in the case where it has been determined in the determination step that the cause of the suspension of the print process is the particular cause, the control portion, in the setting step, displays, on a display portion, a page setting screen including one or more preview images of pages that are candidates for the resumption page, and sets the resumption page in accordance with a user operation performed on the page setting screen.

6. The image forming apparatus according to claim 5, wherein
the control portion, in the setting step, changes the preview images included in the page setting screen in accordance with a user operation performed on the page setting screen.

7. The image forming apparatus according to claim 1, wherein
in the case where it has been determined in the determination step that the cause of the suspension of the print process is not the particular cause, the control portion, in the resuming step, displays, on a display portion, a confirmation screen including a preview image of the resumption page set in the setting step, and resumes the print process in accordance with a user operation performed on the confirmation screen.

8. The image forming apparatus according to claim 1, wherein
in the case where it has been determined in the determination step that the cause of the suspension of the print process is the particular cause, the control portion, in the setting step, displays a message urging confirmation of prints that have been output.

9. An image forming method comprising:
a first step of executing a print process in which a plurality of images of a plurality of pages are printed in sequence based on image data including a plurality of pages;
a second step of, in a case where the print process executed in the first step has been suspended, determining whether or not a cause of the suspension of the print process is a predetermined particular cause;
a third step of, in a case where it has been determined in the second step that the cause of the suspension of the print process is not the particular cause, setting a resumption page from which the print process is to be resumed, to a page following a page that had been output immediately before the print process was suspended, and in a case where it has been determined in the second step that the cause of the suspension of the print process is the particular cause, setting the resumption page in accordance with a user operation; and
a fourth step of resuming the print process from the resumption page set in the third step.
